(19) United States
(12) Patent Application Publication
(10) Pub. No.: US 2019/0078259 A1
(43) Pub. Date: Mar. 14, 2019

(54) METHOD FOR PROCESSING WOOD FIBERS

(71) Applicant: INTERNATIONAL PAPER COMPANY, Memphis, TN (US)

(72) Inventors: Dwight Edward Anderson, Cincinnati, OH (US); David Verd Reed, Blue Ash, OH (US); Leonard E Schuster, Loveland, OH (US)

(21) Appl. No.: 16/128,156

(22) Filed: Sep. 11, 2018

Related U.S. Application Data
(60) Provisional application No. 62/556,691, filed on Sep. 11, 2017.

(51) Int. Cl. D21D 1/24; B02C 2/10; B02C 7/12; D21D 1/36

(52) U.S. Cl. CPC D21D 1/24; D21D 1/36; B02C 7/12; B02C 2/10

(57) ABSTRACT

A method is provided for processing wood fibers comprising providing a refiner comprising a first refining member including first refiner bars and a second refining member including second refiner bars. The first refining member may be spaced from the second refining member to define a refining space therebetween. The first and second refiner bars may be separated by refiner grooves. The method further involves rotating at least one of the first refining member or the second refining member, and supplying a slurry of wood pulp comprising wood fibers to the refiner such that the wood pulp slurry passes through the refining space. The one refining member is rotated at a power level sufficient to create a refining intensity within the refining space of at least about 3 Newtons.

### FIELD OF THE INVENTION

This invention relates generally to processing wood fibers in a refiner.

### BACKGROUND OF THE INVENTION

Cone-type refiners and disc-type refiners have traditionally been used to process wood fibers in a step of a paper product making process. Such refiners included first and second refining members having a refining space therebetween. Each of the first and second refining members included a plurality of refiner bars separated by refiner grooves, wherein the refiner bars defined cutting surfaces for cutting the wood fibers. During operation, at least one of the first and second refining members was rotated relative to the other, wherein rotation of the cutting surfaces of the refiner bars cut wood fibers being processed in the refiner.

Once the wood fibers are processed in the refiner, the processed wood fibers can be further processed in subsequent paper product making processes to produce paper products.

### SUMMARY OF THE INVENTION

In accordance with a first aspect of the present invention, a method is provided for processing wood fibers comprising: providing a refiner comprising a first refining member including first refiner bars and a second refining member including second refiner bars. The first refining member may be spaced from the second refining member to define a refining space therebetween. The first and second refiner bars may be separated by first and second refiner grooves. Each of the first and second refiner grooves has a floor surface. The refining space includes the first and second refiner grooves. The method further comprises: rotating at least one of the first refining member or the second refining member such that the first and second refining members move relative to one another, and supplying a slurry of wood pulp comprising wood fibers to the refiner such that the wood pulp slurry passes through the refining space. The at least one refining member may be rotated at a power level sufficient to create a refining intensity within the refining space of at least about 3 Newtons so as to cause a significant number of long wood fibers in the wood pulp slurry to have their lengths reduced. At least a majority of the refiner grooves of the first and second refining members may have a width extending between adjacent refiner bars falling within a range of from about 6 mm to about 12 mm.

The first refining member may be a rotating rotor member and the second refining member may be a non-rotating stator member.

The first refining member may be rotated at a circumferential velocity of from about 4000 feet/minute to about 6000 feet/minute.

The refining intensity is preferably from about 6 Newtons to about 8 Newtons.

The wood fibers in the wood pulp slurry after passing through the refining space may have a length-weighted mean fiber length and freeness relationship as defined by:

Length-Weighted Mean Fiber Length (mm)≤(0.00484(mm/mls CSF)×freeness(mls CSF))−1.57(mm)

The wood fibers in the wood pulp slurry after passing through the refining space may have a length-weighted mean fiber length and freeness relationship as defined by:

(ΔLength-Weighted Mean Fiber Length (mm)/Δfreeness (mls CSF))>0.00484(mm/mls CSF); or

(ΔLength-Weighted Mean Fiber Length (mm)/Δfreeness (mls CSF))<0.0(mm/mls CSF);

where:
Δ Length-Weighted Mean Fiber Length (mm)=the change in the length-weighted mean fiber length of the wood fibers in the wood pulp slurry from before entering the refiner to after being processed by the refiner; and
Δ freeness (mls CSF)=the change in the freeness of the wood fibers in the wood pulp slurry from before entering the refiner to after being processed by the refiner.

The freeness may be defined by: (mls CSF)≤650 (mls CSF).

At least a majority of the first and second refiner bars may have a width extending between side edges falling within a range of from about 1.5 mm to about 4.0 mm.

At least a majority of the first and second refiner bars may have a height extending from an adjacent groove floor surface of from about 3 mm to about 8 mm.

The length-weighted mean fiber length of softwood fibers in the wood pulp slurry may be from about 1.8 mm to about 3.0 mm before entering the refiner and the length-weighted mean fiber length of processed softwood fibers after being processed by the refiner may be from about 1.0 mm to about 1.6 mm.

The widths of at least a majority of the refiner grooves of the first and second refining members may fall within a range of from about 2× to about 6× a length-weighted mean fiber length of softwood fibers in the wood pulp slurry before entering the refiner.

In accordance with a second aspect of the present invention, a method is provided for processing wood fibers comprising: providing a refiner comprising a first refining member including first refiner bars and a second refining member including second refiner bars. The first refining member may be spaced from the second refining member to define a refining space therebetween. The first and second refiner bars may be separated by first and second refiner grooves. Each of the first and second refiner grooves may have a floor surface. The method further comprises rotating at least one of the first refining member or the second refining member such that the first and second refining members move relative to one another, and supplying a slurry of wood pulp comprising wood fibers to the refiner such that the wood pulp slurry passes through the refining space. At least one member may be rotated at a power level sufficient to create a refining intensity within the refining space of at least about 3 Newtons so as to cause a significant number of long wood fibers in the wood pulp slurry to have their lengths reduced. A frequency at which the first refiner bars cross the second refiner bars may be from about 1500 Hz to about 3500 Hz.

In accordance with a third aspect of the present invention, a method is provided for processing wood fibers comprising: providing a refiner comprising a first refining member including first refiner bars and a second refining member including second refiner bars. The first refining member may be spaced from the second refining member to define a refining space therebetween. The first and second refiner bars may be separated by first and second refiner grooves. Each of the first and second refiner grooves may have a width. The method further comprises: rotating at least one of the first refining member or the second refining member such that the first and second refining members move relative to one another, and supplying a slurry of wood pulp comprising wood fibers to the refiner such that the wood pulp slurry passes through the refining space. The at least one refining member may be rotated at a power level sufficient to create a refining intensity within the refining space of at least about 3 Newtons so as to cause a significant number of long wood fibers in the wood pulp slurry to have their lengths reduced. A ratio of the width for at least a majority of the refiner grooves of the first and second refining members to a length-weighted mean fiber length of the softwood fibers before entering the refining space is preferably at least 2.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a schematic side view of a cone-shaped refiner;

FIG. 2 is a perspective view of first and second refining members;

FIG. 3 is a cross-sectional view of a portion of each of the first and second refining members;

FIG. 4A is a plan view of a section of an inner surface including second refiner bars of the second refining member;

FIG. 4B is a plan view of a section of an outer surface of the first refining member including first refiner bars with second refiner bars shown in phantom and spaced apart and positioned above the first refiner bars;

FIG. 5 illustrates four plots of length-weighted mean fiber length for fibers to freeness (ml CSF); and

FIG. 6 is a table providing refining intensities and related data corresponding to the points of the plots in FIG. 5.

### DETAILED DESCRIPTION OF THE INVENTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

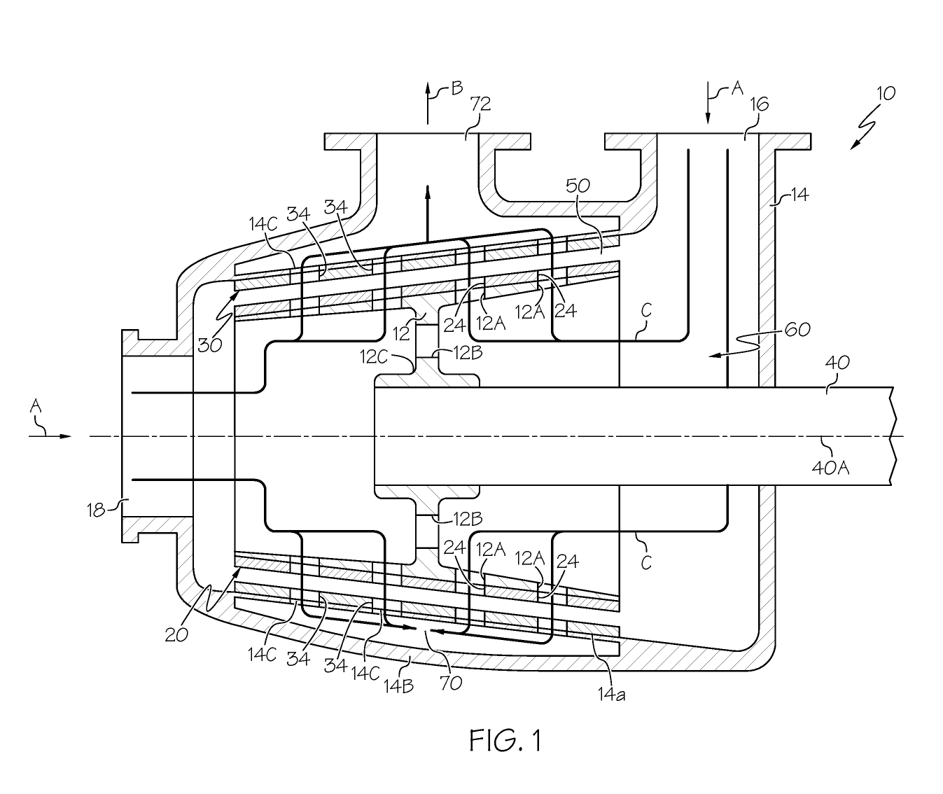

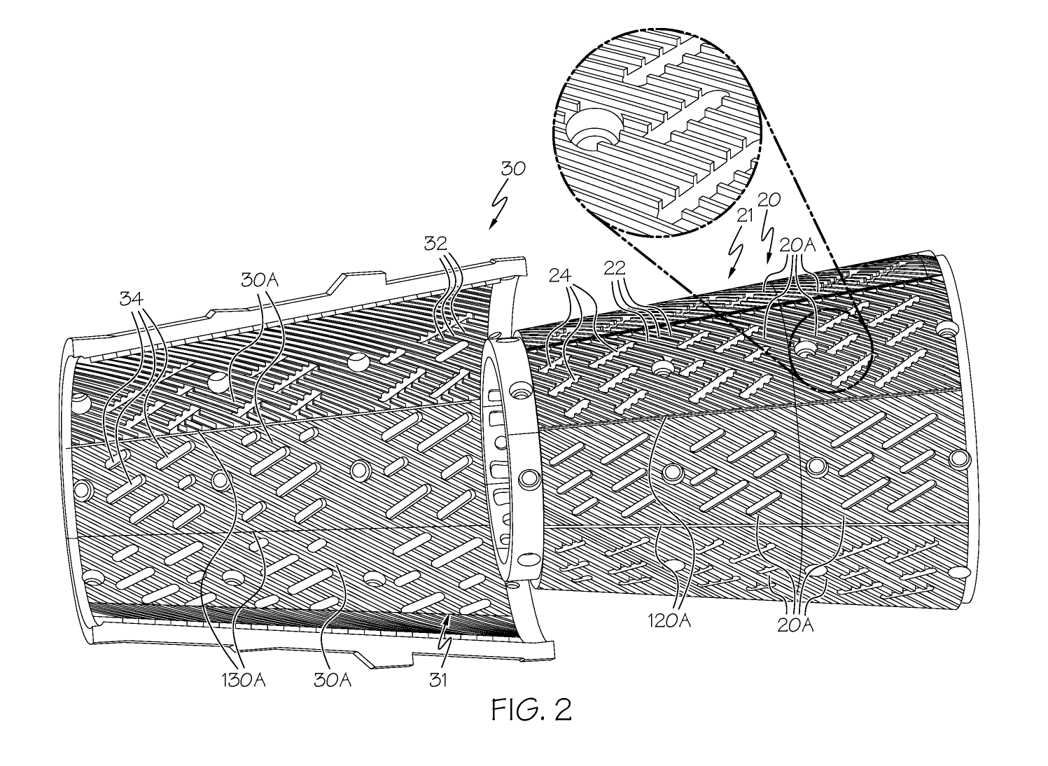

FIG. 1 schematically illustrates a side view of a cone-shaped refiner (hereinafter “cone refiner”) 10 preferably for refining Kraft bleached softwood pulp fibers. It is also contemplated that the cone refiner 10 can be used for any chemical pulp or even recycled fiber at approximately 4% solids content. The cone refiner 10 illustrated in FIG. 1 comprises a first refining member 20 having a generally frustoconical or conical shape and including an outer surface 21 comprising a plurality of first elongated refiner bars 22, see also FIGS. 2-4, and a second refining member 30 having a generally frustoconical or conical shape, positioned about the first refining member 20 and including an inner surface 31 comprising a plurality of second elongated refiner bars 32. The cone refiner 10 further comprises a support frame 12 coupled to and defining a support structure for the first refining member 20. The support frame 12 is also coupled to a rotatable shaft 40 to rotate with the shaft 40. The shaft 40 has a central axis 40A that is generally coaxial with an axis of rotation of the first refining member 20. The shaft 40 is driven by a motor (not shown) such that the first refining member 20 and the first refiner bars 22 rotate with the shaft 40 during operator of the refiner 10. The second refining member 30 is fixed to a circumferential support 14A forming part of a stationary housing or frame 14 of the refiner 10, such that the first member 20 rotates relative to the second member 30. Hence, the first refining member 20, the support 12 and the shaft 40 define a rotor, while the second refining member 30 defines a stator. The cone refiner 10 has similar structure to the one illustrated in U.S. Pat. No. 8,646,708, the disclosure of which is incorporated herein by reference.

The first refining member 20, in the illustrated embodiment, is defined by a plurality of separate first segments 20A bolted or otherwise coupled to the support frame 20, see FIGS. 1 and 2. The second refining member 30 is similarly defined by a plurality of separate second segments 30A bolted or otherwise coupled to the stationary housing support 14A. The number of segments 20A and 30A may vary. It is also contemplated that the first refining member 20 may be defined by a single structure instead of a plurality of segments 20A and the second refining member 30 may also be defined by a single structure.

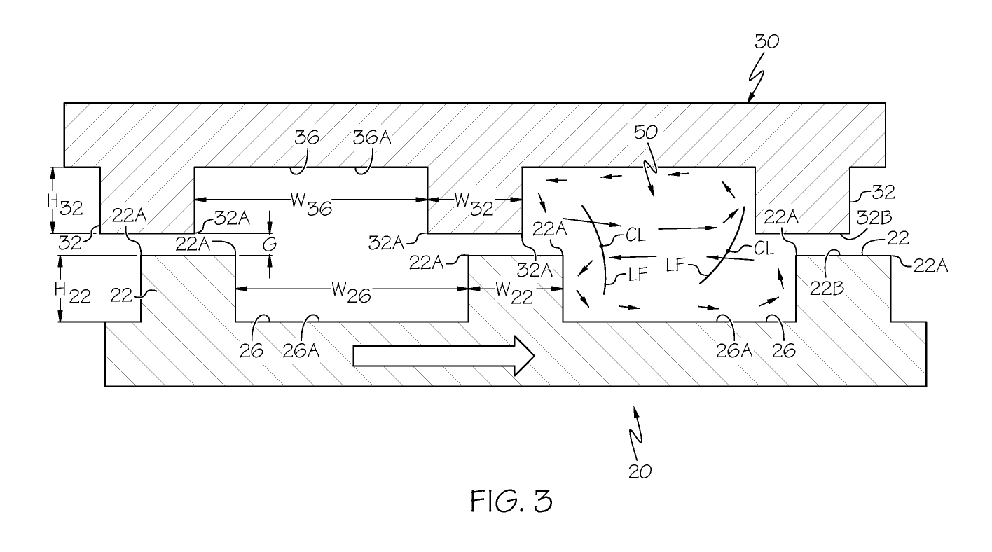

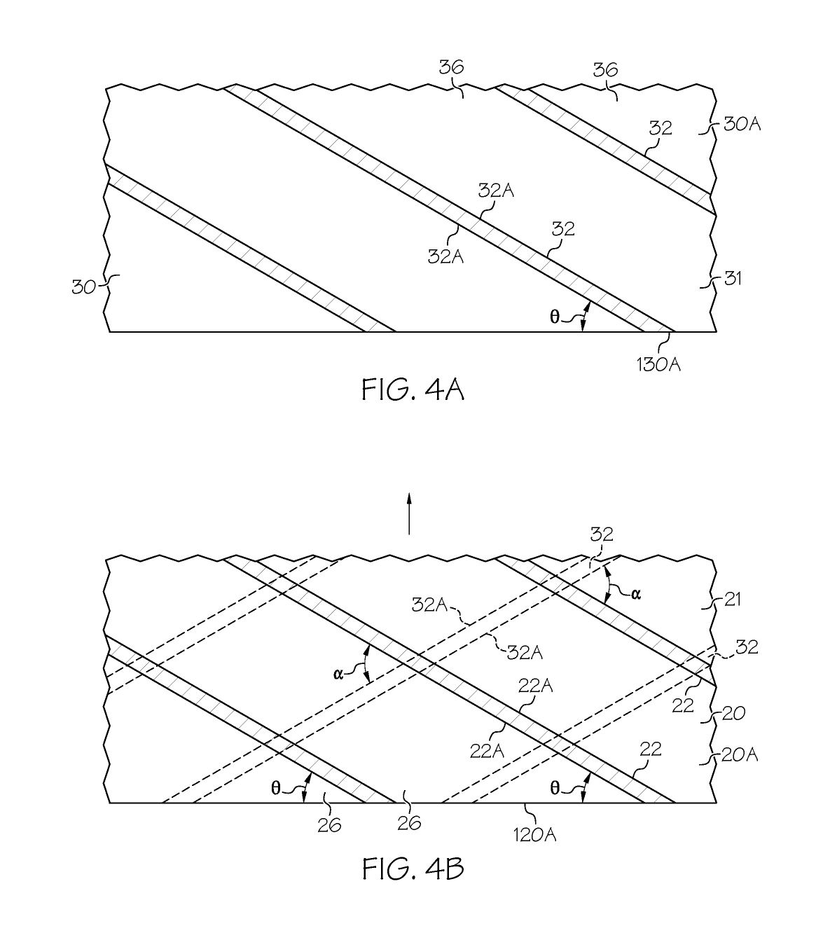

The outer surface 21 of the first refining member 20 and the inner surface 31 of the second refining member 30 are spaced apart to define a refining space 50 therebetween, see FIGS. 1 and 3. As will be discussed further below, a slurry of wood pulp comprising wood fibers LF passes into the refining space 50 such that respective cutting side edges 22A and 32A on the first and second refiner bars 22 and 32, see FIGS. 3, 4A and 4B, cut or sever a significant number of long wood fibers LF in the pulp slurry to reduce the lengths of those wood fibers.

In the illustrated embodiment, the wood pulp slurry enters the cone refiner 10 through first and second inlets 16 and 18 and passes into a refiner inner cavity 60, defined in part by an interior of the support frame 12, see FIG. 1. The support frame 12 includes a plurality of first openings 12A and second openings 12B, see FIG. 1. The first refining member 20 comprises a plurality of first openings 24, oval shaped in the illustrated embodiment, which are generally aligned with the first openings 12A in the support frame 12. The support frame openings 12A and the first openings 24 allow the wood pulp slurry to flow from the inner cavity 60, through the support frame 12 and the first refining member 20 into the refining space 50. Hence, the wood pulp slurry passes from the inner cavity 60, through the support frame openings 12A and the first openings 24 of the first refining member 20 into the refining space 50. The second openings 12B in the support frame 12 allow slurry to move through a radial portion 12C of the support frame 12.

A circumferential exit cavity 70 is defined by the housing circumferential support 14A and an outer wall 14B of the stationary housing 14, see FIG. 1. The circumferential support 14A includes a plurality of openings 14C. The second refining member 30 comprises a plurality of second openings 34, oval shaped in the illustrated embodiment, which are generally aligned with the openings 14C in the circumferential support 14A. The second openings 34 in the second refining member 30 and the openings 14C in the circumferential support 14A allow the wood pulp slurry to pass from the refining space 50, through the second refining member 30 and the circumferential support 14A into the circumferential exit cavity 70 and then through a refiner outlet 72 to exit the refiner 10. Hence, the wood pulp slurry passes from the refining space 50, through the second openings 34 and the circumferential support openings 14C, into the exit cavity 70 and out of the refiner 10 through the outlet 72.

The path that the wood pulp slurry flows through the refiner 10 is illustrated via a solid black line C in FIG. 1. It is noted that there is a wide variation for any one fiber's path as it interacts with the grooves 26 and 36 and the bars 22 and 32.

In the illustrated embodiment, the first refiner bars 22 are separated from one another by first refiner grooves 26, see FIGS. 3 and 4B. The first refiner grooves 26 may each have a floor surface 26A and a width W26 of from about 3 mm to about 18 mm and preferably of from about 6 mm to about 12 mm, see FIG. 3. All or at least a majority of the first refiner bars 22 may each have a width W22 extending between side edges 22A falling within a range of from about 1.5 mm to about 4.0 mm. All or at least a majority of the first refiner bars 22 may each have a height 1122 extending from an adjacent groove floor surface 26A of from about 3 mm to about 8 mm.

The second refiner bars 32 are separated from one another by second refiner grooves 36, see FIGS. 3 and 4A. The second refiner grooves 36 may each have a floor surface 36A and a width W36 of from about 3 mm to about 18 mm and preferably of from about 6 mm to about 12 mm. All or at least a majority of the second refiner bars 32 may each have a width W32 extending between side edges 32A falling within a range of from about 1.5 mm to about 4.0 mm. All or at least a majority of the second refiner bars 32 may each have a height 1132 extending from an adjacent groove floor surface 36A of from about 3 mm to about 8 mm.

The first and second refiner grooves 26 and 36 are considered part of the refining space 50. It is believed that a majority of the flow of slurry of pulp fibers through the refining space 50 passes through the first and second refiner grooves 26 and 36.

The first refining member 30 is located within and spaced from the fixed second refining member 32 such that a gap G, see FIG. 3, is located between respective outer ends 22B, 32B of the first and second refiner bars 22 and 32. The gap G may have a dimension falling within the range of from about 0.05 mm to about 1.00 mm.

As noted above, the first refining member 20 is defined by a plurality of separate first segments 20A. Each segment 20A has first and second side edges 120A, see FIG. 2. In the illustrated embodiment, the first refiner bars 22 are generally positioned relative to a first segment side edge 120A at an angle Θ of about 30 degrees, see FIG. 4B. As also noted above, the second refining member 30 is defined by a plurality of separate second segments 30A. Each segment 30A has first and second side edges 130A, see FIGS. 2 and 4A. In the illustrated embodiment, the second refiner bars 32 are generally positioned relative to a second segment side edge 130A at an angle Θ of about 30 degrees, see FIG. 4A.

In the illustrated embodiment, the first and second refiner bars 22, while spaced apart from one another by the dimension of the gap G, are located relative to one another at an angle α of about 60 degrees, see FIG. 4B, where the second refiner bars 32 are shown in phantom positioned above the first refiner bars 22. In the illustrated embodiment, as the first refining member 20 and the first refiner bars 22 rotate relative to the stationary second refining member 30 and the second refiner bars 32 and the wood pulp slurry is supplied to the refining space 50, the cutting side edges 22A and 32A interact with one another to cut a significant number of long wood fibers LF in the wood pulp slurry moving through the refining space 50 such that the lengths of the long wood fibers LF are reduced.

Preferably, the motor driving the shaft 40 is operated to input an applied motor power sufficient to effect a refining intensity of from about 3 Newtons to about 10 Newtons, where the refining intensity is determined from the equation:

(Applied Motor Power−No Load Power)/[Bar Edge Length/Rev×RPM×(1 minute/60 s)]

Where:

Applied Motor Power=Total motor power applied to shaft 40;

No Load Power=power losses within the refiner;

RPM=motor speed=speed of first refining member;

Bar Edge Length=the total length of all of the first and second refiner bars on the first and second refining members.

The first refining member 20 may be rotated at a circumferential velocity of from about 4000 feet/minute to about 6000 feet/minute.

The first refining member 20 may be rotated at a RPM value such that a frequency at which each of the first refiner bars 22 crosses or passes the stationary second refiner bars 32 is from about 1500 Hz to about 3500 Hz. For example, if the circumferential speed of the first refining member 20 is 22 meters/second and the width of the first and second refiner bars 22 and 32 is 2 mm and the width of the first and second refiner grooves 26 and 36 is 8 mm, then the frequency=22,000 mm/second/10 mm=2200 Hz.

The length-weighted mean fiber length of Kraft bleached softwood fibers in the wood pulp slurry going into the refiner 10 may be from about 1.8 mm to about 3.0 mm before entering the refiner and the length-weighted mean fiber length of processed softwood fibers after being processed by the refiner may be from about 1.0 mm to about 1.6 mm. Length-weighted mean fiber length may be calculated using the following equation:

$$Length \text{-} weighted mean average fiber length = \frac{{\sum }_{i} {n}_{i} {L}_{i}^{2}}{{\sum }_{i} {n}_{i} {L}_{i}}$$

Where nᵢ is the number of fibers in length class Lᵢ, wherein fiber lengths are measured with a Valmet FS5 Fiber Image Analyzer where L₁ is the length fraction from 0.2 to 0.6 mm, L₂ is the length fraction from 0.6 to 1.2 mm, L₃ is the length fraction from 1.2 to 2.0 mm, L₄ is the length fraction from 2.0 to 3.2 mm, and L₅ is the length fraction from 3.2 to 7.0 mm.

As noted above, the first and second refiner grooves 26 and 36 may each have a width W26 and W36 of from about 3 mm to about 18 mm and preferably of from about 6 mm to about 12 mm. As also noted above, the length-weighted mean fiber length of softwood fibers in the wood pulp slurry going into the refiner 10 may be from about 1.8 mm to about 3.0 mm before entering the refiner. A ratio of the width for at least a majority of the refiner grooves 26 and 36 of the first and second refining members 20 and 30 to a length-weighted mean fiber length of the softwood fibers before entering the refining space 50 is preferably at least 2. Further, the widths W26 and W36 of at least a majority of the first and second refiner grooves 26 and 36 of the first and second refining members 20 and 30 may fall within a range of from about 2× to about 6× a length-weighted mean fiber length of softwood fibers in the wood pulp slurry before entering the refiner. It is believed that because the groove widths W26 and W36 are large relative to the length-weighted mean fiber length of the fibers LF in the wood pulp slurry going into the refiner 10, at least a large number of those fibers LF have sufficient room to rotate within the grooves 26 and 36 so as to be positioned generally perpendicular to the width direction of the groove widths W26 and W36, see FIG. 3, allowing those fibers LF to be severed at a location away from the ends of the fibers LF and preferably near or at a center location CL along those fibers.

### EXAMPLES

A refiner similar to the refiner 10 illustrated in FIG. 1 was used to refine a Kraft bleached softwood pulp slurry having softwood fibers with an initial length-weighted mean fiber length of 2.307 mm. The refiner comprised first and second refining members, wherein the first refining member had first refiner bars and first refiner grooves and the second refining member had second refiner bars and second refiner grooves. Each of the first and second refiner grooves had a width W26 and W36 equal to 8.0 mm. Each of the first and second refiner bars had a width W22 equal to 2.0 mm and a height 1122 equal to 7 mm. The first refining member was located within and spaced from the fixed second refining member such that a gap G between the first and second refining members fell within a range of from about 0.05 mm to about 0.96 mm. The first and second refiner bars were generally positioned relative to a side edge of a refining member segment at an angle Θ of about 30 degrees. The first and second refiner bars were located relative to one another at an angle α of about 60 degrees. The cutting edge length equal to the length of all first and second refiner bars was 1.9 Km/revolution.

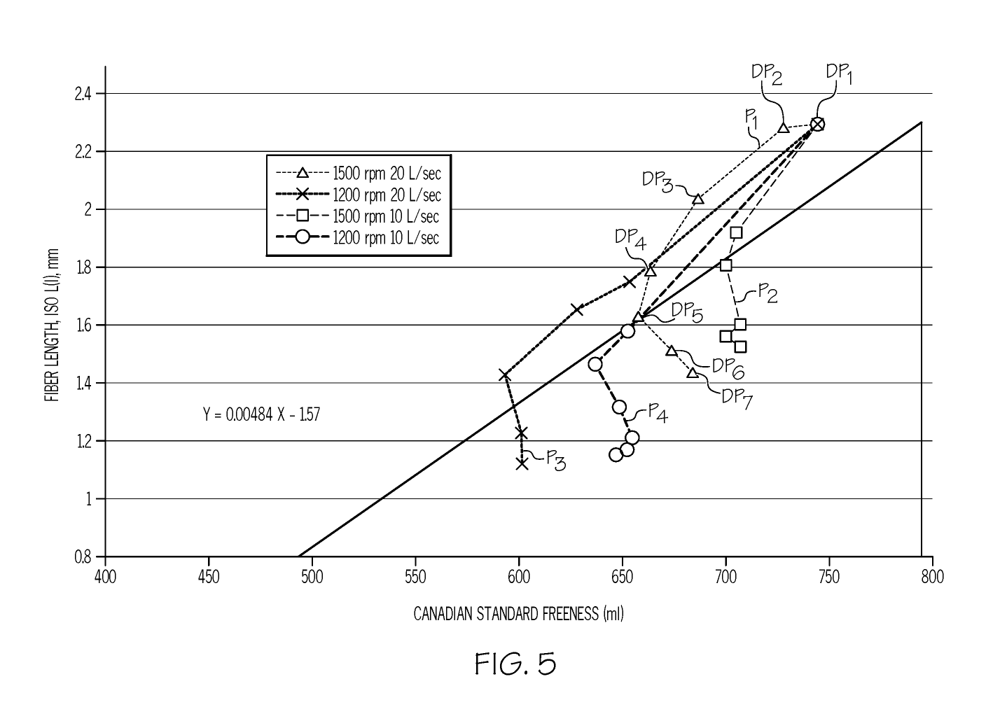

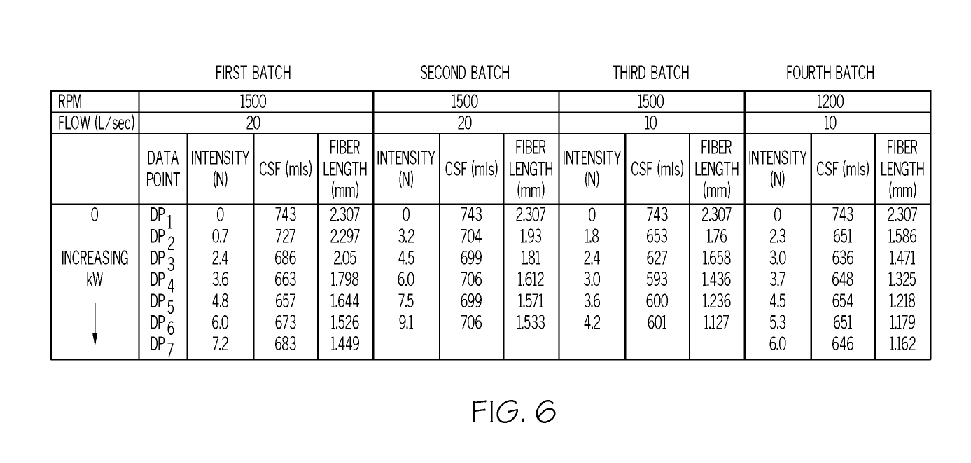

FIG. 5 illustrates four plots P₁-P₄ of length-weighted mean fiber length to freeness (ml CSF) for four batches of softwood pulp slurry, where the first data point DP₁ in Plots P₁-P₄ corresponds to a length-weighted fiber length and freeness for the fibers of the softwood pulp slurry prior to passing through the refiner and the remaining data points in Plots P₁-P₄ correspond to a length-weighted fiber length and freeness for the fibers of the softwood pulp slurry after passing through the refiner at varying refining intensities, see also the table in FIG. 6. It is noted that lower RPM results in higher refining intensity at the same power level.

Plot P₁ corresponds to a first batch of softwood pulp slurry, where that batch passed through the refiner with the flow rate through the refiner equal to 20 liters/second and the motor driving a shaft coupled to the first refining member was operated at 1500 RPM. Plot P₂ corresponds to a second batch of softwood pulp slurry, where that batch passed through the refiner with a flow rate through the refiner equal to 20 liters/second and the motor driving the shaft coupled to the first refining member was operated at 1200 RPM. Plot P₃ corresponds to a third batch of softwood pulp slurry, where that batch passed through the refiner with a flow rate through the refiner equal to 10 liters/second and the motor driving the shaft coupled to the first refining member was operated at 1500 RPM. Plot P₄ corresponds to a fourth batch of softwood pulp slurry, where that batch passed through the refiner with a flow rate through the refiner equal to 10 liters/second and the motor driving the shaft coupled to the first refining member was operated at 1200 RPM.

A triangle is illustrated in FIG. 5, having a hypotenuse defined by the equation:

Y=0.00484(X)−1.57

It is believed that with prior art refiners, most if not all points on a plot of length-weighted mean fiber length for fibers after passing through the refiner to freeness (ml CSF) would be located to the left of the hypotenuse of the triangle in FIG. 5.

As is apparent from FIG. 5, the four plots P₁-P₄ corresponding to the first through fourth batches passing through the refiner in accordance with the present invention have many data points located near or to the right of the hypotenuse of the triangle. Hence, in these batches, especially for the data points near or to the right of the hypotenuse of the triangle, the fibers in the wood pulp slurry were cut so that their length-weighted mean fiber length was reduced while maintaining a high value of freeness, i.e., a higher value of freeness as compared to cut fibers processed using prior art refiners. It is also noted that some data points, such as data points DP₆ and DP₇ on plot P₁, had a reduction in length-weighted mean fiber length from a prior data point, but also had an increase in freeness. Higher freeness values are advantageous as they correspond to faster fluid drainage through the wood pulp during paper product production. It is noted that prior art refiners and processes can achieve low fiber lengths, but not without significant decreases in freeness.

A lower freeness value corresponds to a higher fluid drainage rate through the wood pulp fiber during paper product production.

The table in FIG. 6 provides refining intensity within the refiner for each of the data points on plots P₁-P₄ in FIG. 5. As is apparent from the table in FIG. 6, as refining intensity (N) increases, length-weighted mean fiber length is reduced. For example, the refining intensity for data point DP₆ on plot P₁ is 6.0 Newtons and the corresponding length-weighted mean fiber length after passing through the refiner is 1.526 mm; the refining intensity for data point DP₇ on plot P₁ is 7.2 Newtons and the corresponding length-weighted fiber length after passing through the refiner is 1.449 mm. It is believed that prior art processes for refining bleached softwood Kraft pulp typically had a refining intensity less than 3 Newtons. Higher refining intensities were avoided in the prior art to reduce fiber shortening and freeness CSF reduction.

As is apparent from FIGS. 5 and 6, some of the points on the plots P₁-P₄, such as data points DP₆ and DP₇ on plot P₁, have a length-weighted mean fiber length and freeness relationship, which may be defined by:

Length-Weighted Mean Fiber Length (mm)≤(0.00484 (mm/mls CSF)×freeness (mls CSF))−1.57 (mm)

As is also apparent from FIGS. 5 and 6, some of the points on the plots P₁-P₄, such as data points DP₄-DP₇ on plot P₁, have a length-weighted mean fiber length and freeness relationship, which may be defined by:

(ΔLength-Weighted Mean Fiber Length (mm)/Δfreeness (mls CSF))>0.00484 (mm/mls CSF); or

(ΔLength-Weighted Mean Fiber Length (mm)/Δfreeness (mls CSF))<0.0 (mm/mls CSF);

where:
Δ Length-Weighted Mean Fiber Length (mm)=the change in the length-weighted mean fiber length of the wood fibers in the wood pulp slurry from before entering the refiner to after being processed by the refiner; and
Δ freeness (mls CSF)=the change in the freeness of the wood fibers in the wood pulp slurry from before entering the refiner to after being processed by the refiner.

The freeness (mls CSF) may be ≤650 (mls CSF).

Hence, it is believed that the refiner of the present invention processes, i.e., cuts, a significant number of long fibers in a softwood pulp slurry to reduce their lengths while maintaining a higher freeness value.

It is also contemplated that the present invention could be practiced with other cone-shaped refiners and disc-shaped refiners.

While particular embodiments of the present invention have been illustrated and described, it should be understood that various changes and modifications may be made without departing from the spirit and scope of the invention. It is therefore intended to cover in the appended claims all such changes and modifications that are within the scope of this invention.

What is claimed is:

1. A method for processing wood fibers comprising:
providing a refiner comprising a first refining member including first refiner bars and a second refining member including second refiner bars, the first refining member being spaced from the second refining member to define a refining space therebetween, the first and second refiner bars being separated by first and second refiner grooves, each of the first and second refiner grooves having a floor surface;
rotating at least one of the first refining member or the second refining member such that the first and second refining members move relative to one another; and
supplying a slurry of wood pulp comprising wood fibers to the refiner such that the wood pulp slurry passes through the refining space, wherein the at least one refining member is rotated at a power level sufficient to create a refining intensity within the refining space of at least about 3 Newtons so as to cause a significant number of long wood fibers in the wood pulp slurry to have their lengths reduced;
wherein at least a majority of the refiner grooves of the first and second refining members have a width extending between adjacent refiner bars falling within a range of from about 6 mm to about 12 mm.

2. The method of claim 1, wherein the first refining member is a rotating rotor member and the second refining member is a non-rotating stator member.

3. The method of claim 1, wherein the first refining member is rotated at a circumferential velocity of from about 4000 feet/minute to about 6000 feet/minute.

4. The method of claim 1, wherein the refining intensity is from about 6 Newtons to about 8 Newtons.

5. The method of claim 1, wherein the wood fibers in the wood pulp slurry after passing through the refining space have a length-weighted mean fiber length and freeness relationship as defined by:
Length-Weighted Mean Fiber Length (mm)≤(0.00484 (mm/mls CSF)×freeness (mls CSF))−1.57 (mm)

6. The method of claim 1, wherein the wood fibers in the wood pulp slurry after passing through the refining space have a length-weighted mean fiber length and freeness relationship as defined by:
(ΔLength-Weighted Mean Fiber Length (mm)/Δfreeness (mls CSF))>0.00484 (mm/mls CSF); or
(ΔLength-Weighted Mean Fiber Length (mm)/Δfreeness (mls CSF))<0.0 (mm/mls CSF);
where:
Δ Length-Weighted Mean Fiber Length (mm)=the change in the length-weighted mean fiber length of the wood fibers in the wood pulp slurry from before entering the refiner to after being processed by the refiner; and
Δ freeness (mls CSF)=the change in the freeness of the wood fibers in the wood pulp slurry from before entering the refiner to after being processed by the refiner.

7. The method of claim 6, wherein the freeness (mls CSF)≤650 (mls CSF).

8. The method of claim 1, wherein at least a majority of the first and second refiner bars have a width extending between side edges falling within a range of from about 1.5 mm to about 4.0 mm.

9. The method of claim 1, wherein at least a majority of the first and second refiner bars have a height extending from an adjacent groove floor surface of from about 3 mm to about 8 mm.

10. The method of claim 1, wherein the length-weighted mean fiber length of softwood fibers in the wood pulp slurry is from about 1.8 mm to about 3.0 mm before entering the refiner and the length-weighted mean fiber length of processed softwood fibers after being processed by the refiner is from about 1.0 mm to about 1.6 mm.

11. The method of claim 1, wherein the widths of at least a majority of the refiner grooves of the first and second refining members fall within a range of from about 2× to about 6× a length-weighted mean fiber length of softwood fibers in the wood pulp slurry before entering the refiner.

12. A method for processing wood fibers comprising:
providing a refiner comprising a first refining member including first refiner bars and a second refining member including second refiner bars, the first refining member being spaced from the second refining member to define a refining space therebetween, the first and second refiner bars being separated by first and second refiner grooves, each of the first and second refiner grooves having a floor surface;
rotating at least one of the first refining member or the second refining member such that the first and second refining members move relative to one another; and
supplying a slurry of wood pulp comprising wood fibers to the refiner such that the wood pulp slurry passes through the refining space, wherein the at least one member is rotated at a power level sufficient to create a refining intensity within the refining space of at least about 3 Newtons so as to cause a significant number of long wood fibers in the wood pulp slurry to have their lengths reduced;
wherein a frequency at which the first refiner bars cross the second refiner bars is from about 1500 Hz to about 3500 Hz.

13. The method of claim 12, wherein the first refining member is a rotating rotor member and the second refining member is a non-rotating stator member.

14. The method of claim 12, wherein the first refining member is rotated at a circumferential velocity of from about 4000 feet/minute to about 6000 feet/minute.

15. The method of claim 12, wherein the refining intensity is from about 6 Newtons to about 8 Newtons.

16. The method of claim 12, wherein the wood fibers in the wood pulp slurry after passing through the refining space have a length-weighted mean fiber length and freeness relationship as defined by:
Length-Weighted Mean Fiber Length (mm)≤(0.00484 (mm/mls CSF)×freeness (mls CSF))−1.57 (mm)

17. The method of claim 12, wherein the wood fibers in the wood pulp slurry after passing through the refining space have a length-weighted mean fiber length and freeness relationship as defined by:
(ΔLength-Weighted Mean Fiber Length (mm)/Δfreeness (mls CSF))>0.00484 (mm/mls CSF); or
(ΔLength-Weighted Mean Fiber Length (mm)/Δfreeness (mls CSF))<0.0 (mm/mls CSF);
where:
Δ Length-Weighted Mean Fiber Length (mm)=the change in the length-weighted mean fiber length of the wood fibers in the wood pulp slurry from before entering the refiner to after being processed by the refiner; and
Δ freeness (mls CSF)=the change in the freeness of the wood fibers in the wood pulp slurry from before entering the refiner to after being processed by the refiner.

18. The method of claim 17, wherein the freeness (mls CSF)≤650 (mls CSF).

19. The method of claim 12, wherein the length-weighted mean fiber length of softwood fibers in the wood pulp slurry is from about 1.8 mm to about 3.0 mm before entering the refiner and the length-weighted mean fiber length of processed softwood fibers after being processed by the refiner is from about 1.0 mm to about 1.6 mm.

20. The method of claim 12, wherein the widths of at least a majority of the refiner grooves of the first and second refining members fall within a range of from about 2× to about 6× a length-weighted mean fiber length of softwood fibers in the wood pulp slurry before entering the refiner.

21. A method for processing wood fibers comprising:
providing a refiner comprising a first refining member including first refiner bars and a second refining member including second refiner bars, the first refining member being spaced from the second refining member to define a refining space therebetween, the first and second refiner bars being separated by first and second refiner grooves, each of the first and second refiner grooves having a width;
rotating at least one of the first refining member or the second refining member such that the first and second refining members move relative to one another; and
supplying a slurry of wood pulp comprising wood fibers to the refiner such that the wood pulp slurry passes through the refining space, wherein the at least one refining member is rotated at a power level sufficient to create a refining intensity within the refining space of at least about 3 Newtons so as to cause a significant number of long wood fibers in the wood pulp slurry to have their lengths reduced;
a ratio of the width for at least a majority of the refiner grooves of the first and second refining members to a length-weighted mean fiber length of the softwood fibers before entering the refining space is at least 2.

22. The method of claim 21, wherein the first refining member is a rotating rotor member and the second refining member is a non-rotating stator member.

23. The method of claim 21, wherein the first refining member is rotated at a circumferential velocity of from about 4000 feet/minute to about 6000 feet/minute.

24. The method of claim 21, wherein the refining intensity is from about 6 Newtons to about 8 Newtons.

25. The method of claim 21, wherein the wood fibers in the wood pulp slurry after passing through the refining space have a length-weighted mean fiber length and freeness relationship as defined by:
Length-Weighted Mean Fiber Length (mm)≤(0.00484 (mm/mls CSF)×freeness (mls CSF))−1.57 (mm)

26. The method of claim 21, wherein the wood fibers in the wood pulp slurry after passing through the refining space have a length-weighted mean fiber length and freeness relationship as defined by:
(ΔLength-Weighted Mean Fiber Length (mm)/Δfreeness (mls CSF))>0.00484 (mm/mls CSF); or
(ΔLength-Weighted Mean Fiber Length (mm)/Δfreeness (mls CSF))<0.0 (mm/mls CSF);
where:
Δ Length-Weighted Mean Fiber Length (mm)=the change in the length-weighted mean fiber length of the wood fibers in the wood pulp slurry from before entering the refiner to after being processed by the refiner; and
Δ freeness (mls CSF)=the change in the freeness of the wood fibers in the wood pulp slurry from before entering the refiner to after being processed by the refiner.

27. The method of claim 26, wherein the freeness (mls CSF)≤650 (mls CSF).

28. The method of claim 21, wherein the length-weighted mean fiber length of softwood fibers in the wood pulp slurry is from about 1.8 mm to about 3.0 mm before entering the refiner and the length-weighted mean fiber length of processed softwood fibers after being processed by the refiner is from about 1.0 mm to about 1.6 mm.

29. The method of claim 21, wherein the widths of at least a majority of the refiner grooves of the first and second refining members fall within a range of from about 2× to about 6× a length-weighted mean fiber length of softwood fibers in the wood pulp slurry before entering the refiner.

30. The method of claim 21, wherein the wood fibers comprise Kraft bleached softwood fibers.
